(19) United States
(12) Patent Application Publication
(10) Pub. No.: US 2006/0117277 A1
(43) Pub. Date: Jun. 1, 2006

(54) Circuit design support methods and systems

(75) Inventor: Sheng-Yow Chen, Taichung City (TW)

Correspondence Address: BIRCH STEWART KOLASCH & BIRCH, PO BOX 747, FALLS CHURCH, VA, 22040-0747, US

(73) Assignee: Airoha Technology Corp.

(21) Appl. No.: 11/288,307

(22) Filed: Nov. 29, 2005

(30) Foreign Application Priority Data
Nov. 29, 2004 (TW) 93136720

(51) Int. Cl. G06F 17/50

(52) U.S. Cl. 716/3

(57) ABSTRACT

A method for circuit design support. A netlist file is received. A first 4-terminal device is acquired from the netlist. A second 4-terminal device with the same specifications as the first 4-terminal device is acquired. A first determination is performed to determine whether all control terminals of the first device and all control terminals of the second device are untied-up. A second determination is performed to determine whether all conduction terminals of the first device and all conduction terminals of the second device are tied-up. A relationship indicating that the first 4-terminal device and the second 4-terminal device are a differential pair is output if the first and second determinations are reached.

### BACKGROUND

The invention relates to design support technology, and more particularly, to systems and methods for circuit design support.

Design tools are typically employed by circuit designers in the design of integrated circuits (ICs). The most common design tools are the so-called simulated-program-with-integrated-circuit-emphasis (SPICE) and the fast device level simulators (e.g., Star-Sim, ATS, MACH TA, and TIMEMILL). Typically, design tools, such as SPICE and fast device level simulators, describe an individual device and its connections in a line-by-line manner. Examples of individual devices are resistors, capacitors, inductors, bipolar junction transistors, and metal oxide semiconductor field effect transistors (MOSFETs). In a design tool, each line, which includes a description of a device, is sometimes referred to as a device specification instance.

A netlist developed by a design tool, includes three sections, a circuit description section, a models section, and an analysis section. The circuit description section contains a description of individual device and sub-circuit behavior. Typically, the models section comprises a library of model parameters, model parameter values, and model equations. Generally, the behavior of each type of device (e.g., a MOSFET) can be simulated by at least one model equation, which includes a combination of model parameters. The analysis section typically includes analysis instructions for simulating a device, sub-circuit, or circuit (e.g., output voltage over time) using information in the circuit description section and the models section.

Mismatch effect can be defined as the differences in devices performance for similarly/identically designed devices operating under the same bias conditions. The effect of mismatch is not limited to only among devices; mismatch in device characteristics can lead designed circuits operating under the same bias conditions. Typically, whether among devices or circuits, the performance difference caused by mismatch is not a constant but has a statistical distribution. In particular, the effect of mismatch is dependent on device geometry, distances between devices, layout style, and temperature applied to a device.

Operational amplifiers are the important elements for many analog circuit designs. They are used in numerous applications such as amplifiers and filters. The operational amplifier can be used in two basic configurations: inverting and non-inverting. The differential amplifier is used as the input stage for the operational amplifier. Note that a differential amplifier is only applicable over a limited range of common-mode input. Therefore, to make the operational amplifier versatile, its input stage should work for a rail to rail common-mode input range. For example, the most common method to achieve this range is to use a complementary differential amplifier at the input stage. This method uses an n-type and a p-type differential pairs simultaneously. These differential pairs, however, are sensitive, and device mismatch occurs therein will lead to malfunction of the entire circuit. Thus, careful design is imperative to avoid the mismatch effect. Typically, the differential pairs are difficult to identify from a netlist or a schematic diagram containing numerous devices by circuit designers.

### SUMMARY

Methods for circuit design support are provided. An embodiment of a method, executed by a processing unit, comprises receiving a netlist file, acquiring a first 4-terminal device from the netlist, acquiring a second 4-terminal device with the same specifications as the first 4-terminal device from the netlist, performing a first determination according to scripts in the netlist to determine whether all control terminals of the first device and all control terminals of the second device are not tied-up, performing a second determination according to scripts in the netlist to determine whether all conduction terminals of the first device and all conduction terminals of the second device are tied-up, and outputting a relationship indicating that the first 4-terminal device and the second 4-terminal device are a differential pair if the first and second determinations are reached.

Also provided is a machine-readable storage medium storing a computer program which, when executed, performs circuit design support functions.

Systems for circuit design support are further provided. The system comprises a storage device, an output device and a processing unit. The storage device stores a netlist file. The processing unit couples to the storage device and the output device, receiving the netlist file, acquires a first 4-terminal device from the netlist, acquires a second 4-terminal device with the same specifications as the first 4-terminal device from the netlist, performs a first determination according to scripts in the netlist to determine whether all control terminals of the first device and all control terminals of the second device are not tied-up, performs a second determination according to scripts in the netlist to determine whether all conduction terminals of the first device and all conduction terminals of the second device are tied-up, and outputs a relationship indicating that the first 4-terminal device and the second 4-terminal device are a differential pair if the first and second determinations are reached. The output device may connect to a display or a printer.

The second determination may further determine whether all devices connecting to the conduction terminals of the first 4-terminal, and all devices connecting to the conduction terminals of the second 4-terminal are symmetrically connected. The first and second 4-terminal devices may be acquired by a netlist parser or acquired based on syntax formats for 4-terminal devices.

Preferably, the 4-terminal devices are MOSFETs (Metal Oxide Semiconductor Field Effect Transistors) or BJTs (Bipolar Junction Transistors). The control terminals are gates of MOSFETs or bases of BJTs. The conduction terminals are drains and sources of MOSFETs, or emitters and collectors of BJTs.

### BRIEF DESCRIPTION OF THE DRAWINGS

The aforementioned objects, features and advantages of the invention will become apparent by referring to the following detailed description of embodiment with reference to the accompanying drawings, wherein:

FIG. 1 is a diagram of a hardware environment of a circuit design support system according to an embodiment of the invention;

FIGS. 2a and 2b are flowcharts showing an embodiment of a method for MOSFET differential pair detection;

FIG. 3 is a screen diagram of an exemplary netlist file;

FIG. 4 is a schematic diagram corresponding to an exemplary netlist;

FIGS. 5a and 5b are flowcharts showing an embodiment of a method for BJT differential pair detection;

FIG. 6 is a screen diagram of an exemplary netlist file;

FIG. 7 is a schematic diagram corresponding to an exemplary netlist;

FIG. 8 is a diagram of a storage medium for storing a computer program providing an embodiment of a method for circuit design support.

### DETAILED DESCRIPTION

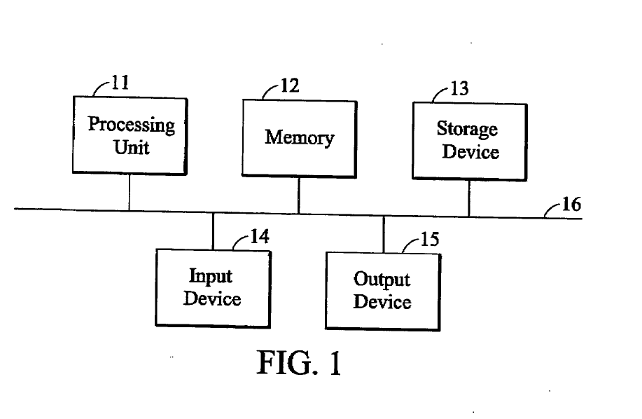

FIG. 1 is a diagram of a hardware environment of a circuit design support system according to an embodiment of the invention. The description of FIG. 1 is provides a brief, general description of suitable computer hardware and a suitable computing environment in conjunction with which at least some embodiments may be implemented. The hardware environment of FIG. 1 includes a processing unit 11, a memory 12, a storage device 13, an input device 14, an output device 15 and a communication device 16. The processing unit 11 is connected by buses 16 to the memory 12, storage device 13, input device 14, output device 15 and communication device 16 based on Von Neumann architecture. Those skilled in the art will understand that at least some embodiments may be practiced with other computer system configurations, including hand-held devices, multiprocessor-based, microprocessor-based or programmable consumer electronics, network PCs, minicomputers, mainframe computers, and the like. There may be one or more processing units 21, such that the processor of the computer comprises a single central processing unit (CPU), a micro processing unit (MPU) or multiple processing units, commonly referred to as a parallel processing environment. Memory 12 is preferably a random access memory (RAM), but may also include read-only memory (ROM) or flash ROM. The memory 12 preferably stores program modules executed by the processing unit 11 to perform circuit design support functions. Generally, program modules include routines, programs, objects, components, or others, that perform particular tasks or implement particular abstract data types. Some embodiments may also be practiced in distributed computing environments where tasks are performed by remote processing devices linked through a communication network. In a distributed computing environment, program modules may be located in both local and remote memory storage devices based on various remote access architecture such as DCOM, CORBA, Web object, Web Services or other similar architectures. The storage device 13 may be a hard drive, magnetic drive, optical drive, a portable drive, or nonvolatile memory drive. The drives and their associated computer-readable media (if required) provide nonvolatile storage of computer-readable instructions, data structures, program modules, texts, graphics, audio or video files. Storage device 13 stores a netlist file.

A pair of 4-terminal devices is usually implemented in a differential amplifier. 4-terminal devices comprise n-type, p-type MOSFET (Metal Oxide Semiconductor Field Effect Transistor), npn-type, pnp-type BJT (Bipolar Junction Transistor) and the like. A 4-terminal device comprises a control terminal such as a MOSFET gate or a BJT base, to control the turning on/off of the device, and two conduction terminals such as a drain and a source of MOSFET, or an emitter and a collector of BJT to transmit signals.

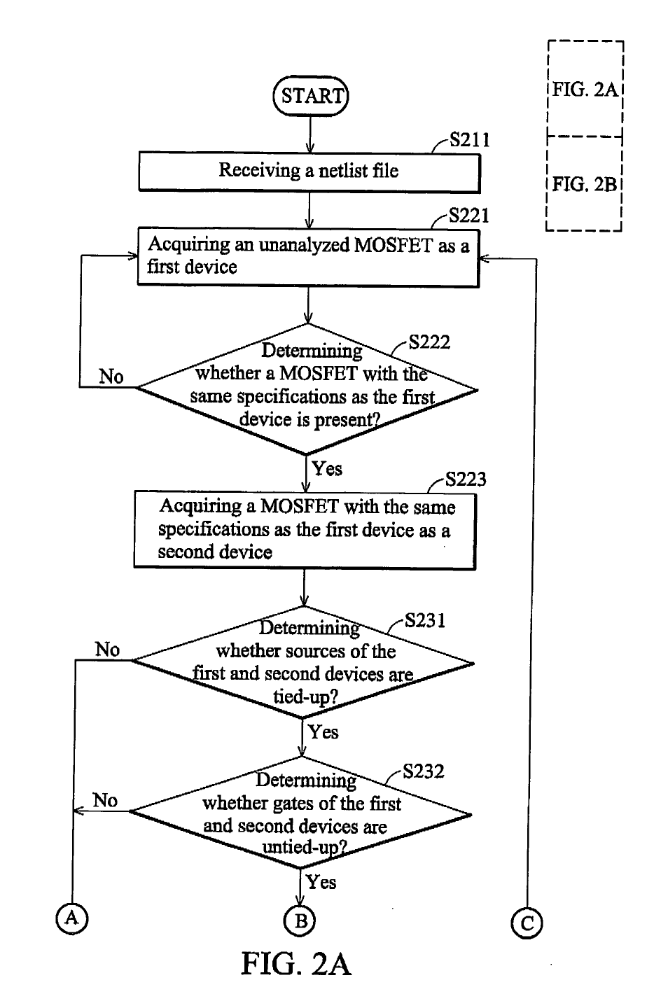

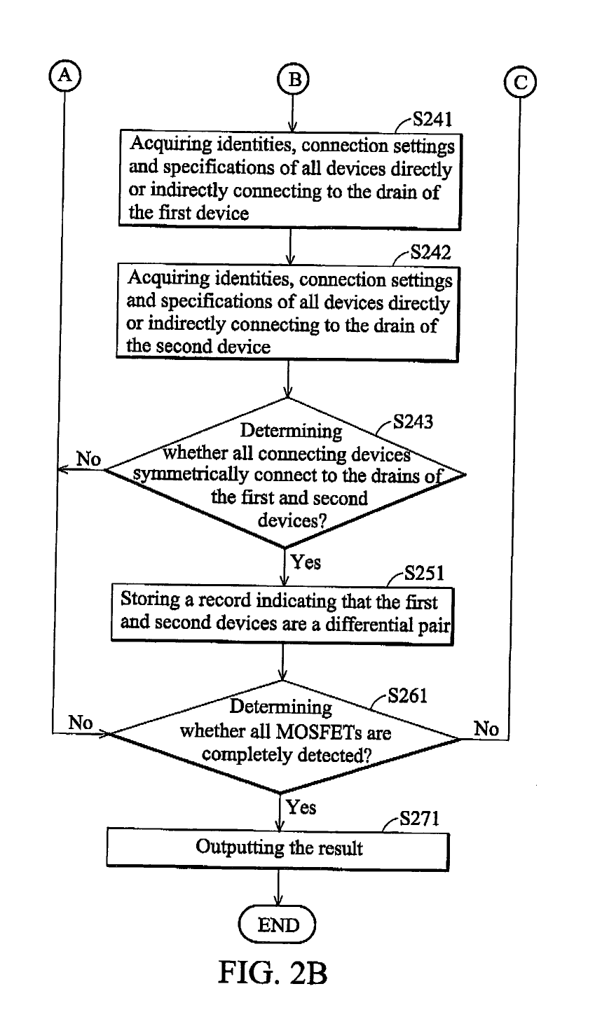

An embodiment of a method for MOSFET differential pair detection is executed by the processing unit 11. FIGS. 2a and 2b are flowcharts showing an embodiment of a method for MOSFET differential pair detection. In step S211, a netlist file is received. In step S221, an unanalyzed MOSFET is acquired as a first device. In some examples, for an unanalyzed MOSFET, an identity, connection settings between terminals such as sources, drains and gates, and specifications such as widths, lengths, oxide thickness or others, are acquired by a netlist parser. In some examples, a script is first acquired by detecting keywords of an unanalyzed MOSFET, such as “nfets”, “pfets” and the like, therein, and subsequently, identities, connection settings between terminals, and specifications are acquired from the acquired scripts based on MOSFET syntax formats. In step S222, it is determined whether a MOSFET with the same specifications as the first device is present, and, if so, the process proceeds to step S223, and otherwise, to step S221. In some examples, identities, connection settings between terminals, and specifications for all MOSFETs other than the first device, are acquired by a netlist parser, specifications for all acquired MOSFETs are compared with specifications for the first device, and it is determined whether specifications of an acquired MOSFET with the same specifications as the first device is present. In some examples, all MOSFET scripts other than the script of first device, are acquired by detecting keywords of MOSFETs, such as “nfets”, “pfets” and the like, therein, identities, connection settings between terminals and specifications for all acquired MOSFETs, are acquired from the acquired scripts based on MOSFET syntax formats, and it is determined whether specifications of an acquired MOSFET with the same specifications as the first device is present. In step S223, a MOSFET with the same specifications as the first device is acquired as a second device, and specifications thereof are further acquired.

In step S231, it is determined whether sources of the first and second devices are tied-up, and, if so, the process proceeds to step S232, and otherwise, to step S261. Specifically, it is determined whether source parameters of the first and second devices are both set to the same contact, or whether devices (e.g. resistors) connected by sources of the first and second devices are both set to the same contact. In step S232, it is determined whether gates of the first and second devices are untied-up, and, if so, the process proceeds to step S241, and otherwise, to step S261. Specifically, it is determined whether gate parameters of the first and second devices are set to different contacts.

In step S241, identities, connection settings and specifications of all devices directly or indirectly connecting to the drain of the first device are acquired from the netlist file. In some examples, identities, connection settings and specifications of all devices set in the connection setting of the drain of the first device, are acquired by a netlist parser. In some examples, all scripts corresponding to all devices set in the connection setting of the drain of the first device, are first acquired by a string comparison algorithm, and subsequently, identities, connection settings and specifications for these devices, are acquired from the acquired scripts based on various syntax formats, such as resistor, capacitor, inductance or other syntax formats, employed in the netlist. In step S242, identities, connection settings and specifications of all devices directly or indirectly connecting to the drain of the second device, are acquired from the netlist file. In some examples, identities, connection settings and specifications of all devices set in the connection setting of the drain of the second device, are acquired by a netlist parser. In some examples, all scripts corresponding to all devices set in the connection setting of the drain of the second device, are first acquired by a string comparison algorithm, and subsequently, identities, connection settings and specifications for these devices, are acquired from the acquired scripts based on various syntax formats, such as resistor, capacitor, inductance or other syntax formats, employed in the netlist. In step S243, it is determined whether all devices detected by the steps S241 and S242 symmetrically connect to the drains of the first and second devices by comparing identities, connection settings and specifications of all devices directly or indirectly connecting to the drain of the first device with that of all devices directly or indirectly connecting to the drain of the second device, and if so, the process proceeds to step S251, and otherwise, to step S261.

In step S251, a record indicating that the first and second devices are a differential pair is stored in the memory 12 or storage device 13. In step S261, it is determined whether all MOSFETs are completely detected, and, if so, the process proceeds to step S271, and otherwise, to step S221. In step S271, all detected differential pairs are displayed or printed via the output device 15.

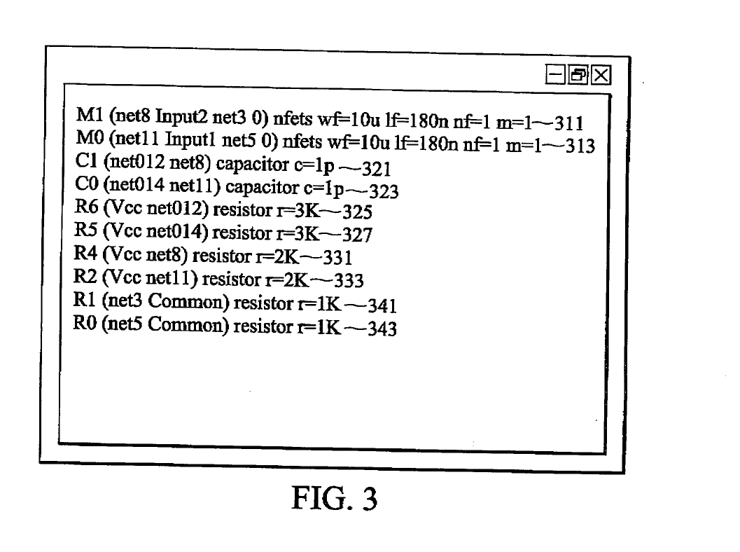

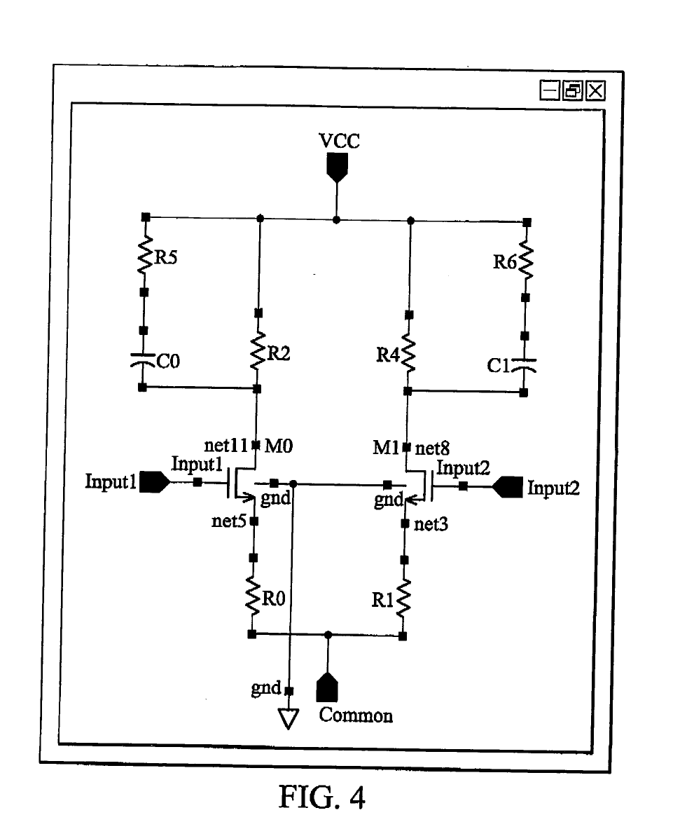

Details of the method for MOSFET differential pair detection are illustrated in the following examples. In step S211, a netlist file is acquired. FIG. 3 is a screen diagram of an exemplary netlist file including scripts 311 to 343. FIG. 4 is a schematic diagram corresponding to the exemplary netlist as shown in FIG. 3. In step S221, a MOSFET is acquired from the netlist file as a first device, in which, referring the script 311, identity, connection settings of drain, gate and source, and device specifications for the first device are respectively “M1”, “net8”, “Input2”, “net3” and “wf=10u lf=180n nf=1 m=1”. In steps S222 and S223, a MOSFET with the same specifications as the first device is acquired as a second device, in which, referring to the script 313, identity, connection settings of drain, gate and source, and device specifications for the second device are respectively “M0”, “net11”, “Input1”, “net5” and “wf=10u lf=180n nf=1 m=1”. In step S231, referring to the scripts 311, 313, 341 and 343, it is determined that the drains of the first and second devices are tied-up by detecting that the drain of the first device connects to a resistor “R1”, the drain of the second device connects to a resistor “R0” and the resistors “R1” and “R0” connects to the same contact “Common”. In step S232, referring to the scripts 311 and 313, it is determined that the gates of the first and second devices are untied-up by detecting that the gate of the first device connects to a contact “Input2” and the gate of the second device connects to a contact “Input1”. In step S241, referring to the scripts 311, 321, 325 and 331, identities, connection settings and device specifications of all devices connecting to the drain of the first device, are acquired. The acquired devices include a capacitor “C1” and a resistor “R4” directly connecting to the drain of the first device, and a resistor “R6” connecting to the drain of the first device via the capacitor “C1”. Device specifications of the capacitor “C1”, resistors “R4” and “R6” are respectively “c=1p”, “r=2k” and “r=3k”. In step S242, referring to the scripts 313, 323, 327 and 333, identities, connection settings and device specifications of all devices connecting to the drain of the second device, are acquired. The acquired devices include a capacitor “C0” and a resistor “R2” directly connecting to the drain of the second device, and a resistor “R5” connecting to the drain of the second device via the capacitor “C0”. Device specifications of the capacitor “C0”, resistors “R2” and “R5” are respectively “c=1p”, “r=2k” and “r=3k”. In step S243, that the acquired capacitors “C1” and “C0”, and resistors “R4”, “R6”, “R2” and “R5” symmetrically connect to the drains of the first and second devices, is detected. In step S251, a result indicating that the MOSFETs “M1” and “M0” are a differential pair, is stored. In steps S261 and S271, the result indicating that the MOSFETs “M1” and “M0” are a differential pair, is output.

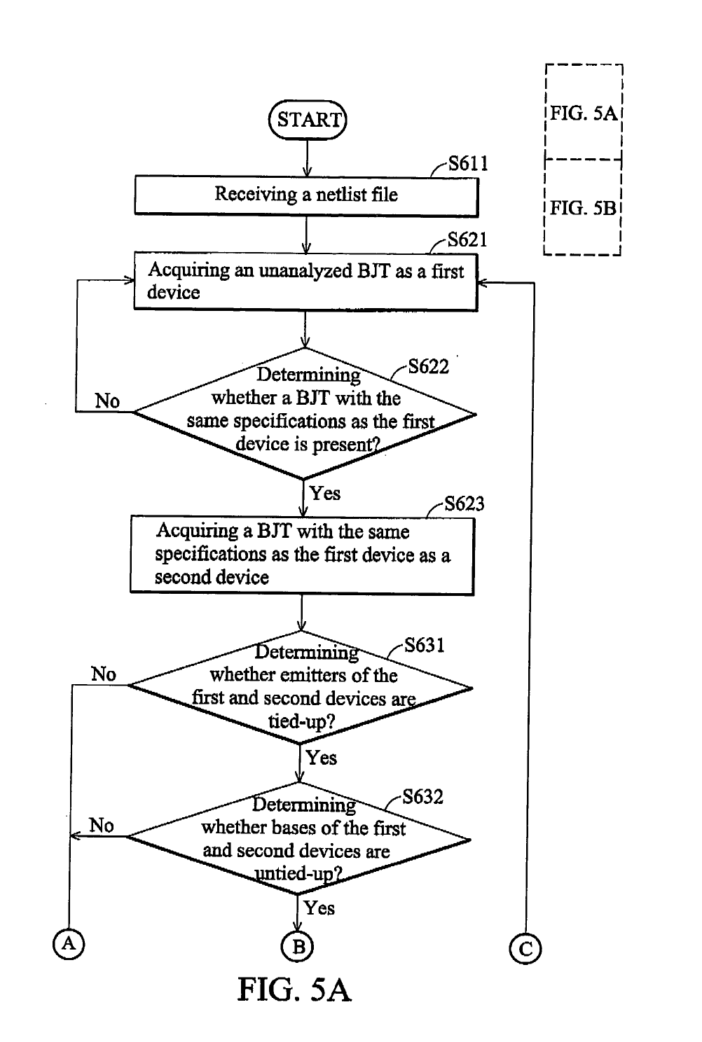

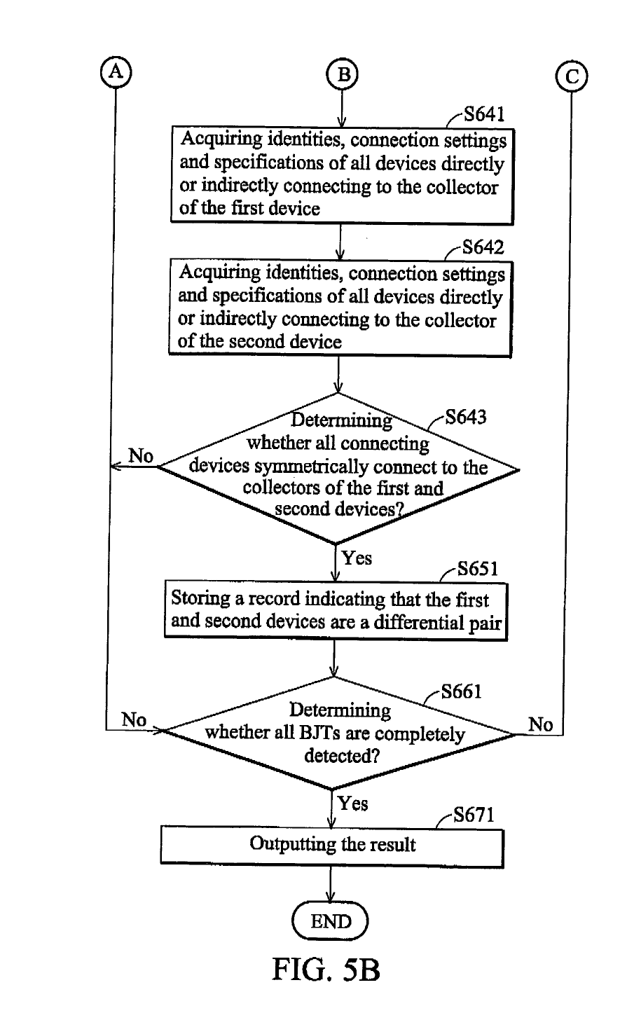

An embodiment of a method for BJT differential pair detection is executed by the processing unit 11. FIGS. 5a and 5b are flowcharts showing an embodiment of a method for BJT differential pair detection. In step S611, a netlist file is received. In step S621, an unanalyzed BJT is acquired as a first device. In some examples, for an unanalyzed BJT, an identity, connection settings between terminals such as emitters, collectors and bases, and specifications such as widths, lengths or others, are acquired by a netlist parser. In some examples, a script is first acquired by detecting keywords of an unanalyzed BJT, such as “npn”, “pnp” and the like, therein, and subsequently, identities, connection settings between terminals, and specifications are acquired from the acquired scripts based on BJT syntax formats. In step S622, it is determined whether a BJT with the same specifications as the first device is present, and, if so, the process proceeds to step S623, and otherwise, to step S621. In some examples, identities, connection settings between terminals and specifications for all BJTs other than the first device, are acquired by a netlist parser, specifications for all acquired BJTs are compared with specifications for the first device, and it is determined whether specifications of an acquired BJT with the same specifications as the first device is present. In some examples, all BJT scripts other than the script of first device, are acquired by detecting keywords of BJTs, such as “npn”, “pnp” and the like, therein, identities, connection settings between terminals and specifications for all acquired BJTs, are acquired from the acquired scripts based on BJT syntax formats, and it is determined whether specifications of an acquired BJT with the same specifications as the first device is present. In step S623, a BJT with the same specifications as the first device is acquired as a second device, and specifications thereof are further acquired.

In step S631, it is determined whether emitters of the first and second devices are tied-up, and, if so, the process proceeds to step S632, and otherwise, to step S2661. Specifically, it is determined whether emitter parameters of the first and second devices are both set to the same contact, or whether devices (e.g. resistors) connected by emitters of the first and second devices are both set to the same contact. In step S632, it is determined whether bases of the first and second devices are untied-up, and, if so, the process proceeds to step S641, and otherwise, to step S661. Specifically, it is determined whether base parameters of the first and second devices are set to different contacts.

In step S641, identities, connection settings and specifications of all devices directly or indirectly connecting to the collector of the first device, are acquired from the netlist file. In some examples, identities, connection settings and specifications of all devices set in the connection setting of the collector of the first device, are acquired by a netlist parser. In some examples, all scripts corresponding to all devices set in the connection setting of the collector of the first device, are first acquired by a string comparison algorithm, and subsequently, identities, connection settings and specifications for these devices, are acquired from the acquired scripts based on various syntax formats, such as resistor, capacitor, inductance or other syntax formats, employed in the netlist. In step S642, identities, connection settings and specifications of all devices directly or indirectly connecting to the collector of the second device, are acquired from the netlist file. In some examples, identities, connection settings and specifications of all devices set in the connection setting of the collector of the second device, are acquired by a netlist parser. In some examples, all scripts corresponding to all devices set in the connection setting of the collector of the second device, are first acquired by a string comparison algorithm, and subsequently, identities, connection settings and specifications for these devices, are acquired from the acquired scripts based on various syntax formats, such as resistor, capacitor, inductance or other syntax formats, employed in the netlist. In step S643, it is determined whether all devices detected by the steps S641 and S642 symmetrically connect to the collectors of the first and second devices by comparing identities, connection settings and specifications of all devices directly or indirectly connecting to the collector of the first device with that of all devices directly or indirectly connecting to the collector of the second device, and if so, the process proceeds to step S651, and otherwise, to step S661.

In step S651, a record indicating that the first and second devices are a differential pair is stored in the memory 12 or storage device 13. In step S661, it is determined whether all BJTs are completely detected, and, if so, the process proceeds to step S671, and otherwise, to step S621. In step S671, all detected differential pairs are displayed or printed via the output device 15.

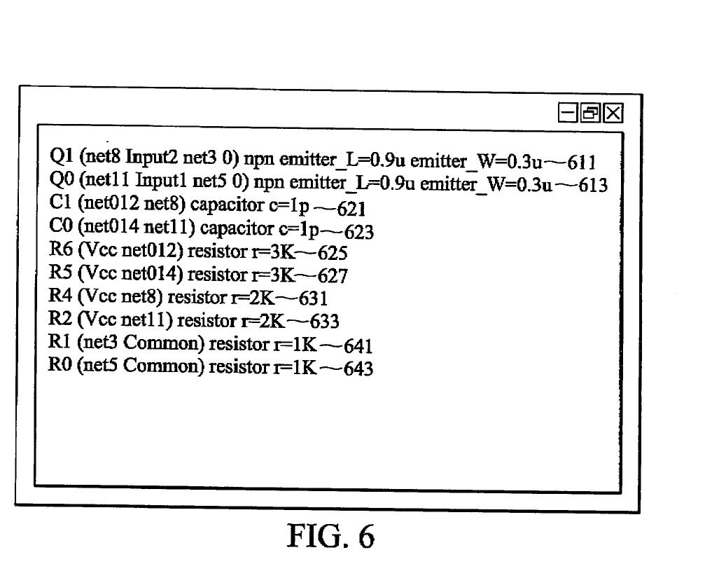

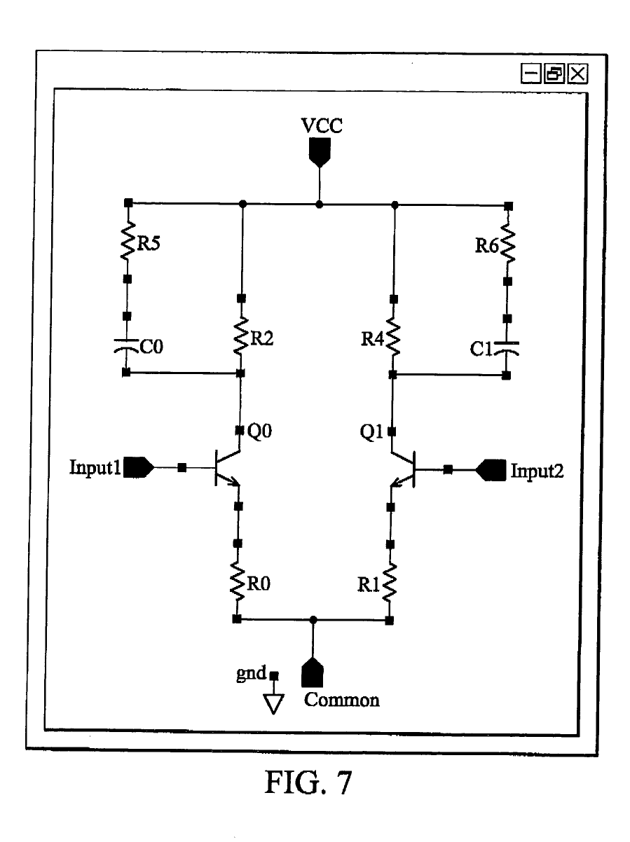

Details of the method for BJT differential pair detection are illustrated in the following examples. In step S611, a netlist file is acquired. FIG. 6 is a screen diagram of an exemplary netlist file including scripts 611 to 643. FIG. 7 is a schematic diagram corresponding to the exemplary netlist as shown in FIG. 6. In step S621, a BJT is acquired from the netlist file as a first device, in which, referring the script 611, identity, connection settings of collector, base and emitter, and device specifications for the first device are respectively “Q1”, “net8”, “Input2”, “net3” and “emitter_L=0.9u emitter_W=0.3u”. In steps S622 and S623, a BJT with the same specifications as the first device is acquired as a second device, in which, referring to the script 613, identity, connection settings of collector, base and emitter, and device specifications for the second device are respectively “Q0”, “net11”, “Input1”, “net5” and “emitter_L=0.9u emitter_W=0.3u”. In step S631, referring to the scripts 611, 613, 641 and 643, it is determined that the emitters of the first and second devices are tied-up by detecting that the emitter of the first device connects to a resistor “R1”, the emitter of the second device connects to a resistor “R0” and the resistors “R1” and “R0” connects to the same contact “Common”. In step S632, referring to the scripts 611 and 613, it is determined that the bases of the first and second devices are untied-up by detecting that the base of the first device connects to a contact “Input2” and the base of the second device connects to a contact “Input1”. In step S641, referring to the scripts 611, 621, 625 and 631, identities, connection settings and device specifications of all devices connecting to the collector of the first device, are acquired. The acquired devices includes a capacitor “C1” and a resistor “R4” directly connecting to the collector of the first device, and a resistor “R6” connecting to the collector of the first device via the capacitor “C1”. Device specifications of the capacitor “C1”, resistors “R4” and “R6” are respectively “c=1p”, “r=2k” and “r=3k”. In step S642, referring to the scripts 613, 623, 627 and 633, identities, connection settings and device specifications of all devices connecting to the collector of the second device, are acquired. The acquired devices includes a capacitor “C0” and a resistor “R2” directly connecting to the drain of the second device, and a resistor “R5” connecting to the collector of the second device via the capacitor “C0”. Device specifications of the capacitor “C0”, resistors “R2” and “R5” are respectively “c=1p”, “r=2k” and “r=3k”. In step S643, that the acquired capacitors “C1” and “C0”, and resistors “R4”, “R6”, “R2” and “R5” symmetrically connect to the collectors of the first and second devices, is detected. In step S651, a result indicating that the BJTs “Q1” and “Q0” are a differential pair, is stored. In steps S661 and S671, the result indicating that the BJTs “Q1” and “Q0” are a differential pair, is output.

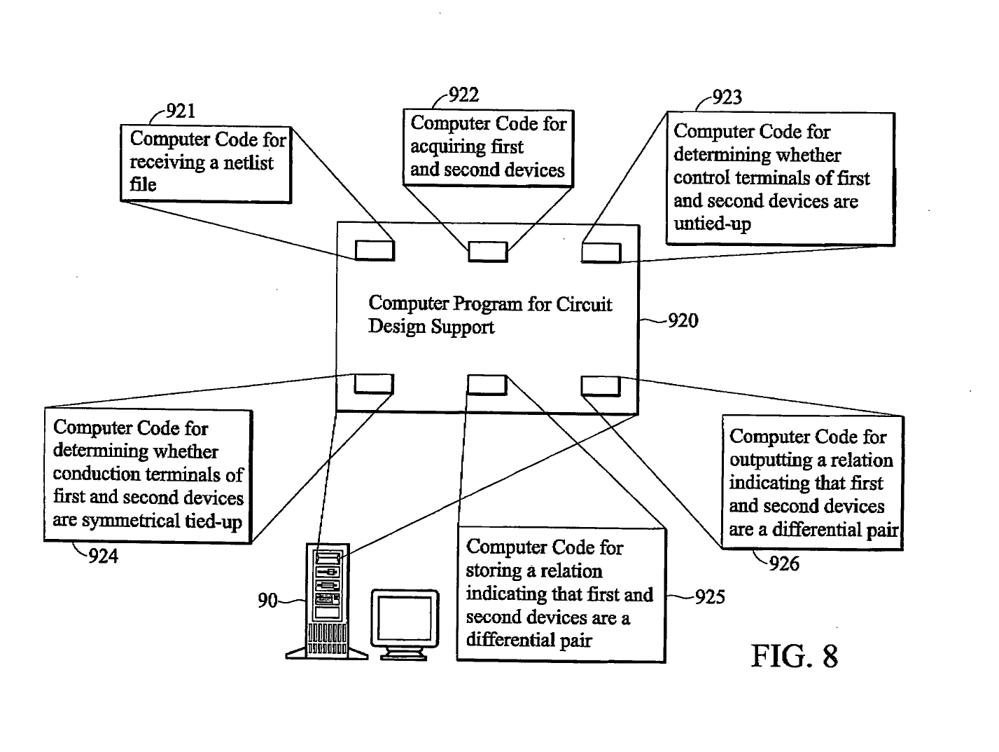

Further provided is a storage medium as shown in FIG. 8 storing a computer program 920 for executing the disclosed method of circuit design support. The computer program product includes a storage medium 90 having computer readable program code embodied in the medium for use in a computer system, the computer readable program code comprising at least computer readable program code 921 receiving a netlist file, computer readable program code 922 acquiring first and second devices, computer readable program code 923 determining whether control terminals of first and second devices are untied-up, computer readable program code 924 determining whether conduction terminals of first and second devices are symmetrical tied-up, computer readable program code 925 storing a relationship indicating that first and second devices are a differential pair and computer readable program code 926 outputting a relationship indicating that first and second devices are a differential pair.

The methods and systems disclosed, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

Although the invention has been described in terms of preferred embodiment, it is not intended to limit the invention thereto. Those skilled in this technology can make various alterations and modifications without departing from the scope and spirit of the invention. Therefore, the scope of the invention shall be defined and protected by the following claims and their equivalents.

What is claimed is:

1. A method for circuit design support, executed by a processing unit, comprising:
receiving a netlist file;
acquiring a first 4-terminal device from the netlist;
acquiring a second 4-terminal device with the same specifications as the first 4-terminal device from the netlist;
performing a first determination according to scripts in the netlist to determine whether all control terminals of the first device and all control terminals of the second device are untied-up;
performing a second determination according to scripts in the netlist to determine whether all conduction terminals of the first device and all conduction terminals of the second device are tied-up; and
outputting a relationship indicating that the first 4-terminal device and the second 4-terminal device are a differential pair if the first and second determinations are reached.

2. The method as claimed in claim 1 wherein the second determination further determines whether all devices connecting to the conduction terminals of the first 4-terminal, and all devices connecting to the conduction terminals of the second 4-terminal are symmetrically connected.

3. The method as claimed in claim 1 wherein the 4-terminal devices are MOSFETs (Metal Oxide Semiconductor Field Effect Transistors) or BJTs (Bipolar Junction Transistors).

4. The method as claimed in claim 1 wherein the control terminals are gates of MOSFETs (Metal Oxide Semiconductor Field Effect Transistors) or bases of BJTs (Bipolar Junction Transistors).

5. The method as claimed in claim 1 wherein the conduction terminals are drains and sources of MOSFETs (Metal Oxide Semiconductor Field Effect Transistors), or emitters and collectors of BJTs (Bipolar Junction Transistors).

6. The method as claimed in claim 1 wherein the first and second 4-terminal devices are acquired by a netlist parser or acquired based on syntax formats for 4-terminal devices.

7. The method as claimed in claim 1 wherein the control terminals are gates of MOSFETs (Metal Oxide Semiconductor Field Effect Transistors) or bases of BJTs (Bipolar Junction Transistors), and the conduction terminals are drains and sources of MOSFETs, or emitters and collectors of BJTs.

8. A machine-readable storage medium storing a computer program which, when executed, performs a method for circuit design support, the method comprising:
receiving a netlist file;
acquiring a first 4-terminal device from the netlist;
acquiring a second 4-terminal device with the same specifications as the first 4-terminal device from the netlist;
performing a first determination according to scripts in the netlist to determine whether all control terminals of the first device and all control terminals of the second device are untied-up;
performing a second determination according to scripts in the netlist to determine whether all conduction terminals of the first device and all conduction terminals of the second device are tied-up; and
setting and outputting a relationship indicating that the first 4-terminal device and the second 4-terminal device are a differential pair if the first and second determinations are reached.

9. A system for circuit design support comprising:
a storage device storing a netlist file;
an output device; and
a processing unit coupling to the storage device and the output device, receiving the netlist file, acquiring a first 4-terminal device from the netlist, acquiring a second 4-terminal device with the same specifications as the first 4-terminal device from the netlist, performing a first determination according to scripts in the netlist to determine whether all control terminals of the first device and all control terminals of the second device are untied-up, performing a second determination according to scripts in the netlist to determine whether all conduction terminals of the first device and all conduction terminals of the second device are tied-up, and outputting a relationship indicating that the first 4-terminal device and the second 4-terminal device are a differential pair if the first and second determinations are reached.

10. The system as claimed in claim 9 wherein the second determination further determines whether all devices connecting to the conduction terminals of the first 4-terminal, and all devices connecting to the conduction terminals of the second 4-terminal are symmetrically connected.

11. The system as claimed in claim 9 wherein the 4-terminal devices are MOSFETs (Metal Oxide Semiconductor Field Effect Transistors) or BJTs (Bipolar Junction Transistors).

12. The system as claimed in claim 9 wherein the control terminals are gates of MOSFETs (Metal Oxide Semiconductor Field Effect Transistors) or bases of BJTs (Bipolar Junction Transistors).

13. The system as claimed in claim 9 wherein the conduction terminals are drains and sources of MOSFETs (Metal Oxide Semiconductor Field Effect Transistors), or emitters and collectors of BJTs (Bipolar Junction Transistors).

14. The system as claimed in claim 9 wherein the first and second 4-terminal devices are acquired by a netlist parser or acquired based on syntax formats for 4-terminal devices.

15. The system as claimed in claim 9 wherein the control terminals are gates of MOSFETs (Metal Oxide Semiconductor Field Effect Transistors) or bases of BJTs (Bipolar Junction Transistors), and the conduction terminals are both drains and sources of MOSFETs, or both emitters and collectors of BJTs.

16. The system as claimed in claim 9 wherein the output device connects to a displayer or a printer.
